(19) United States
(12) Patent Application Publication
(10) Pub. No.: US 2007/0291476 A1
(43) Pub. Date: Dec. 20, 2007

(54) SELF-ASSEMBLY CANDELABRA

(76) Inventor: Kuo-Chi Kuo, Changhua Hsien (TW)

Correspondence Address: LEONG C LEI, PMB # 1008, 1867 YGNACIO VALLEY ROAD, WALNUT CREEK, CA, 94598, US

(21) Appl. No.: 11/425,147

(22) Filed: Jun. 20, 2006

(51) Int. Cl. F21V 35/00

(52) U.S. Cl. 362/161

(57) ABSTRACT

A candelabrum contains a number of candlesticks, each having a drip pan supported by an arm. The arms of two or more candlesticks can be bundled together by a flexible sleeving device. The flexibility of the sleeving devices make the bundling very easy to conduct. In addition, the arms of the candlesticks bundled together can have arbitrary included angles among them. As such, the candlesticks can be joined and arranged freely into various geometrical shapes.

### BACKGROUND OF THE INVENTION

(a) Technical Field of the Invention

The present invention generally relates to candelabra, and more particularly to a candelabrum assembled by joining multiple candlesticks with sleeving members.

(b) Description of the Prior Art

Conventionally, a candelabrum is capable of arranging and holding a number of candles to enhance the artistic feel of candle lighting. However, the arrangement of the candles by the candelabrum is usually a fixed one.

To remove the constraint, there are self-assembly candelabra whose candlesticks are joined together by steel wires, which is difficult to assemble and re-arrange. A better approach is therefore desired.

### SUMMARY OF THE INVENTION

The primary purpose of the present invention is provide a self-assembly candelabrum to obviate the forgoing shortcomings of the prior arts.

The candelabrum contains a number of candlesticks, each having a drip pan supported by an arm. The arms of two or more candlesticks can be bundled together by a flexible sleeving device. The flexibility of the sleeving devices make the bundling very easy to conduct. In addition, the arms of the candlesticks bundled together can have arbitrary included angles among them. As such, the candlesticks can be joined and arranged freely into various geometrical shapes.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing the candlestick of a candelabrum according to a first embodiment of the present invention.

FIG. 2 is a perspective diagram showing the candlestick of a candelabrum according to a second embodiment of the present invention.

FIG. 3 is a perspective diagram showing two candlesticks of FIG. 1 are joined together by a sleeving device of the present invention.

FIG. 4A & 4B is a sectional schematic diagram showing the stretching of the sleeving device when it binds the arms of two candlesticks together.

FIG. 5 is a perspective diagram showing the candlestick of a candelabrum according to a third embodiment of the present invention.

FIG. 6 is perspective diagram showing a first candelabrum assembled by the candlesticks of FIG. 1.

FIG. 7 is perspective diagram showing a second candelabrum assembled by the candlesticks of FIG. 1.

FIG. 8 is perspective diagram showing a third candelabrum assembled by the candlesticks of FIG. 1.

FIG. 9 is perspective diagram showing a fourth candelabrum assembled by the candlesticks of FIG. 1.

FIG. 10 is a perspective diagram showing the candlestick of a candelabrum according to a fourth embodiment of the present invention where the sleeving device is a rigid one.

### DETAILED DESCRIPTION OF THE PREFERRED EMBODIMENT

The following description are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

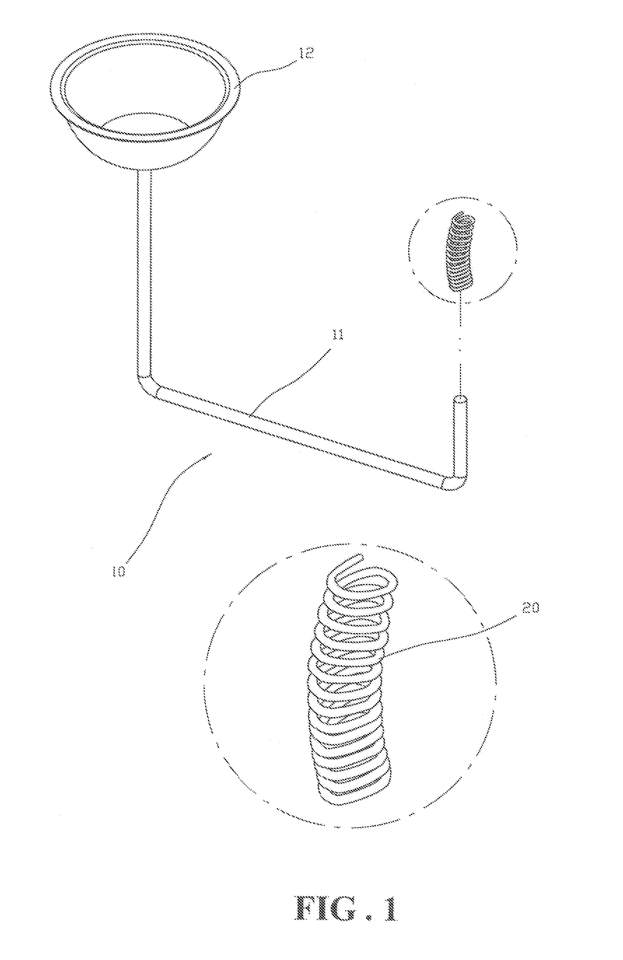

A candelabrum according to the present invention contains a number of candlesticks 10 and at least a sleeving device 20. As illustrated in FIG. 1, an embodiment of the candlestick 10 has a drip pan 12 for holding a candle supported at an end of a U-shaped arm 11 made of steel bar.

As illustrated, an embodiment of the sleeving device 20 is a helix spring formed by winding a steel cable. The helix spring has a roughly 75-degree curvature. The aperture of the helix spring can accommodate the steel bars of the arms 11 of two candlesticks 10.

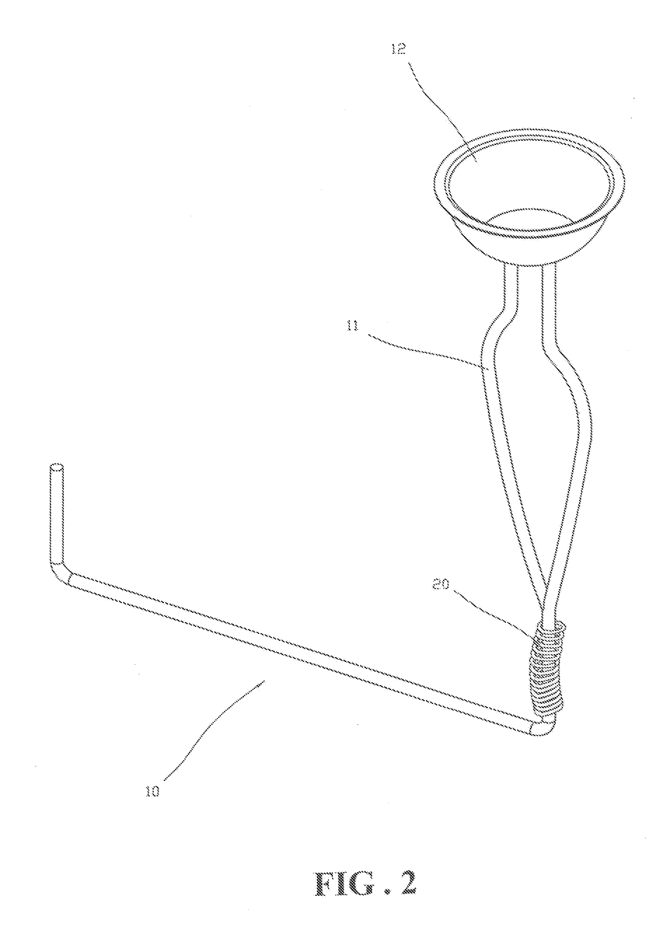

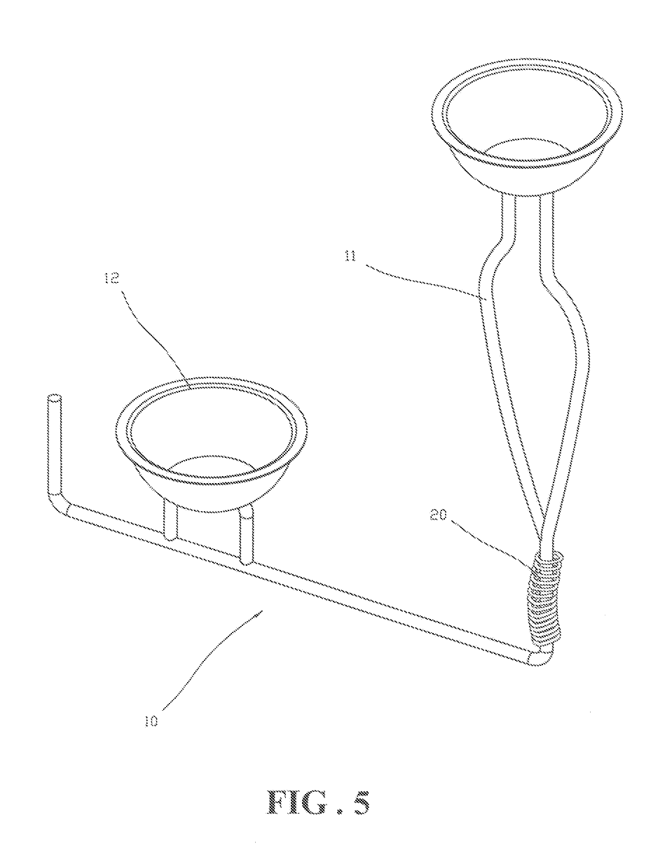

FIG. 2 is another embodiment of the candlestick 10, where the drip pan 12 is supported by two steel bars forked from an end of the arm 11. FIG. 5 is yet another embodiment of the candlestick 10, where an addition drip pan 12 is provided at an appropriate location along the arm 11.

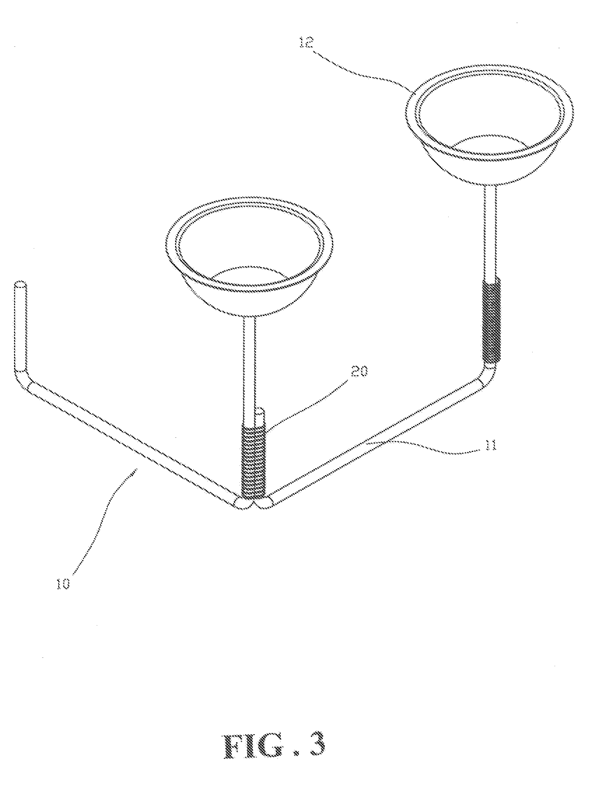

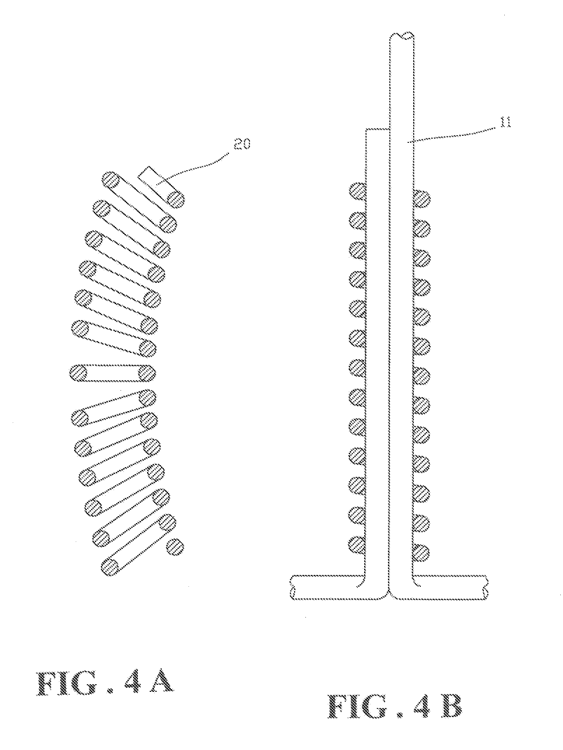

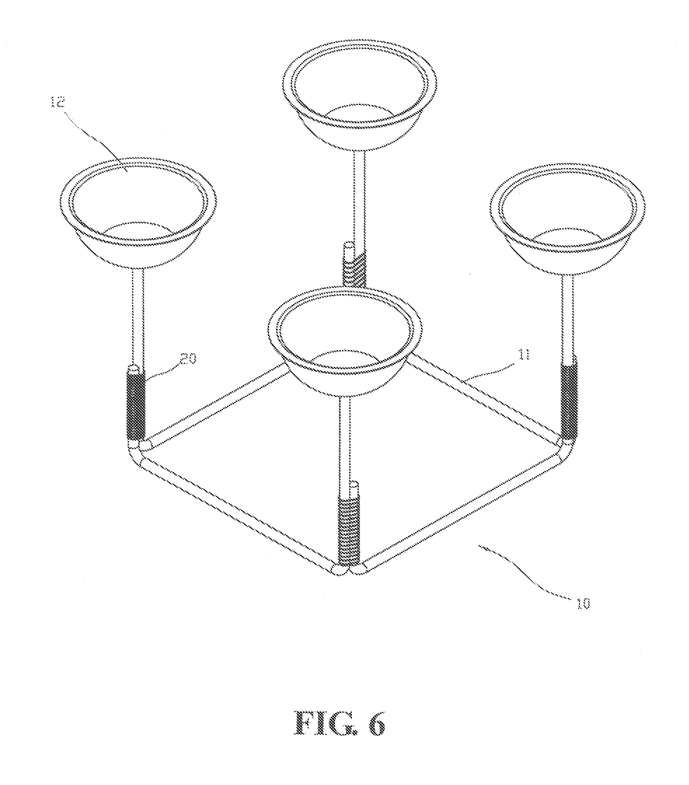

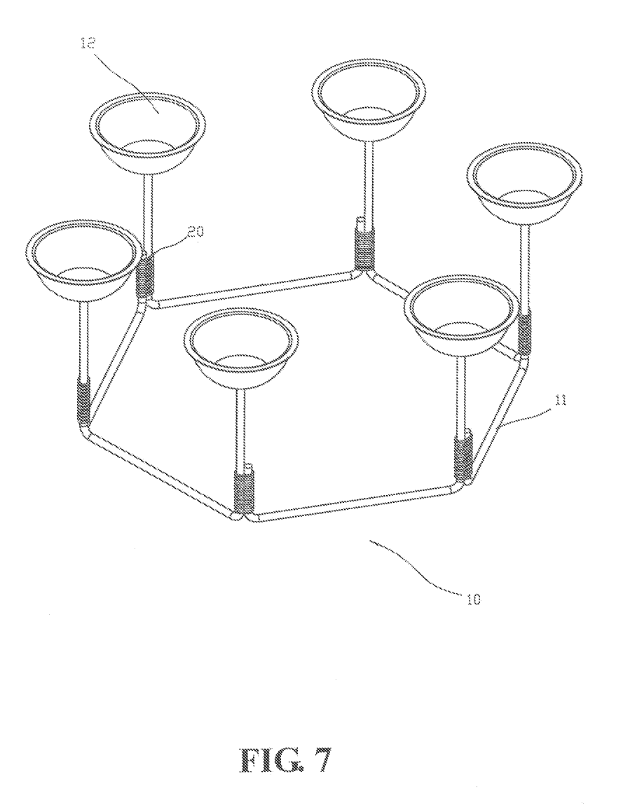

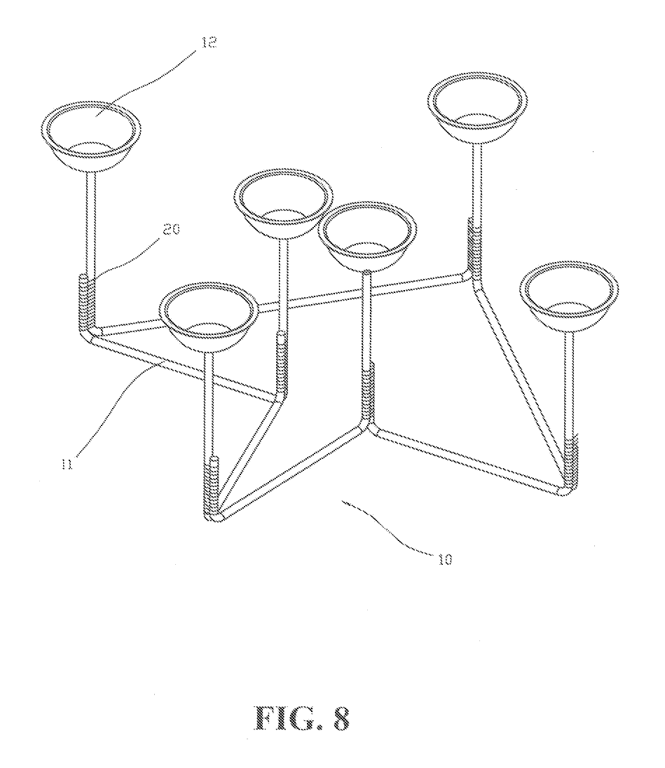

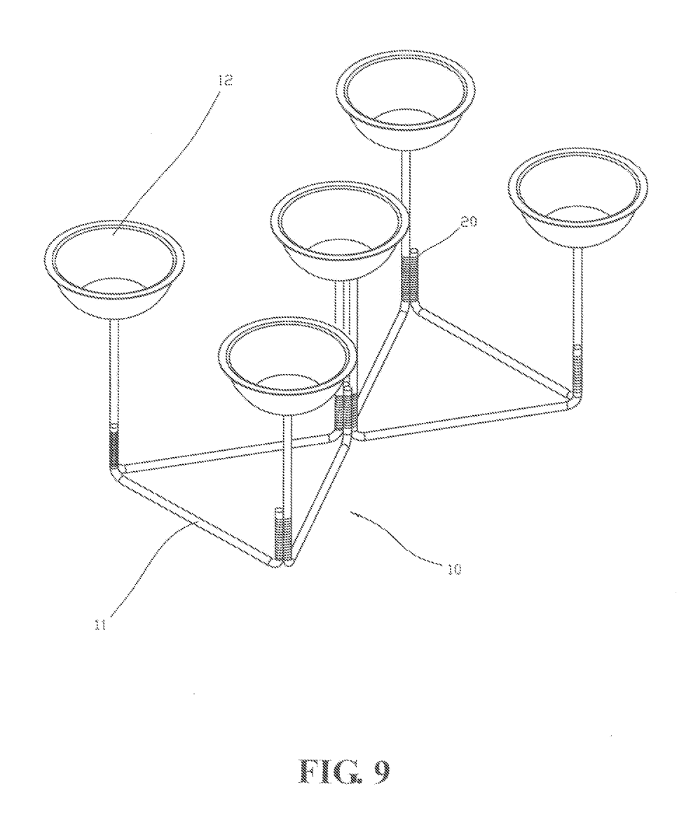

As shown in FIGS. 3, 4A and 4B, to join two candlesticks 10 together, a sleeving device 20 is sleeved over the arm 11 of a first candlestick 10 and is positioned on the vertical segment beneath the drip pan 12. Then, the other vertical segment of a second candlestick 10 si threaded through the sleeving device 20. As illustrated, the curved sleeving device 20 is stretched straight as such and the resilience of the sleeving device 20 tightly joins the two arms 11 together. As the sleeving device 20 only binds the two arms 11 together and the included angle between the two arms 11 can still be arbitrarily altered, multiple candlesticks 10 can be cascaded one by one into a candelabrum of a desired geometrical shape, as shown in FIGS. 6 to 9.

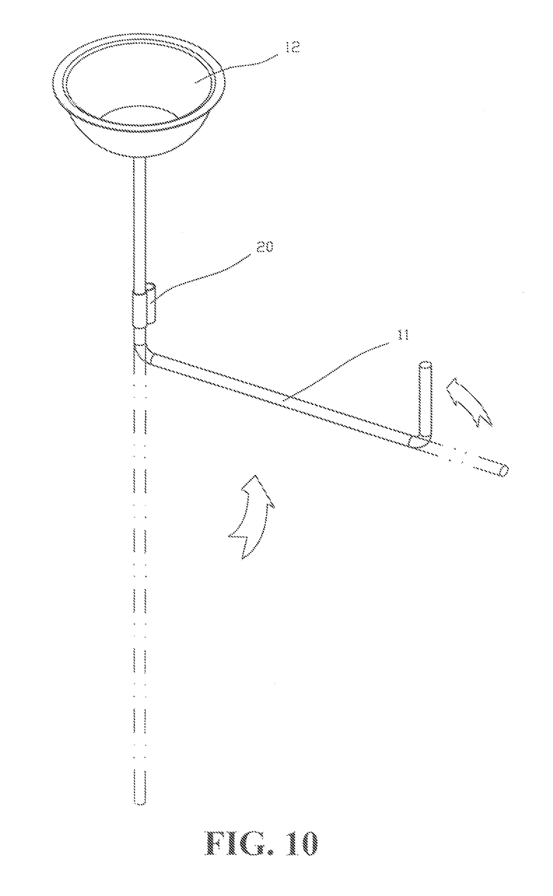

The present invention provides two types of sleeving devices 20; a flexible one and a rigid one. The foregoing helix spring is a flexible one. A rubber tube is another embodiment of a flexible sleeving device 20. The flexible sleeving device 20 tights the candlesticks 10 together by the resilience resulted from its deformation and can be manufactured separately. In contrast, a hard sleeving device 20 is made of a metallic material or plastics and relies on its rigidness to hold the arms 11 together. A hard sleeving device 20 is installed onto a candlestick during the fabrication of the candlestick. Then the steel bar of the arm 11 is bended into the desired shape, as shown in FIG. 10.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A candelabrum having a plurality of candlesticks and at least a sleeving device; wherein
each said candlestick comprises a drip pan supported at an end of an arm;
said sleeving device is capable of tightly joining the arms of at least two said candlesticks together whose included angle therebetween is adjustable.

2. The candelabrum according to claim 1, wherein said sleeving device is a helix spring having an appropriate curvature.

3. The candelabrum according to claim 1, wherein said sleeving device is a rubber tube.

4. The candelabrum according to claim 1, wherein said sleeving device is a rigid object made of plastics or a metallic material.
